(19) United States
(12) Patent Application Publication
(10) Pub. No.: US 2026/0161422 A1
(43) Pub. Date: Jun. 11, 2026

(54) INFORMATION PROCESSING APPARATUS AND BIOS UPDATE METHOD

(71) Applicant: Lenovo (Singapore) Pte. Ltd., Singapore (SG)

(72) Inventors: Zuying Wo, Kanagawa (JP); Kazuya Shibayama, Kanagawa (JP); Mikio Hagiwara, Kanagawa (JP); Ke Ma, Kanagawa (JP)

(73) Assignee: Lenovo (Singapore) Pte. Ltd., Singapore (SG)

(21) Appl. No.: 19/182,011

(22) Filed: Apr. 17, 2025

(30) Foreign Application Priority Data
May 14, 2024 (JP) 2024-078597

(51) Int. Cl. G06F 9/445; G06F 8/65

(52) U.S. Cl. CPC G06F 9/44505; G06F 8/65

(57) ABSTRACT

An information processing apparatus includes a BIOS storage unit that stores at least a BIOS program, a main control unit that starts an OS by executing the BIOS program, and a sub-control unit that manages peripheral devices and is able to access the BIOS storage unit, wherein the BIOS storage unit has a first area that stores the current BIOS program and a second area for use in storing the BIOS update program, and wherein the sub-control unit has a BIOS update unit that stores the BIOS update program acquired by the main control unit in the second area during the BIOS update process, executes a restart, and enables the update program stored in the second area as the BIOS program.

### CROSS-REFERENCE TO RELATED APPLICATIONS

This application claims priority to Japanese Patent Application No. 2024-078597 filed on May 14, 2024, the contents of which are hereby incorporated herein by reference in their entirety.

### Technical Field

Embodiments of the present disclosure include an information processing apparatus and a basic input output system (BIOS) update method.

### Background

In recent years, a technique for safely updating the BIOS of information processing apparatuses such as personal computers (PCs) has become known (refer to, for example, Japanese Unexamined Patent Application Publication No. 2015-153334). In such conventional information processing apparatuses, a lock is placed on the BIOS storage unit that stores a BIOS program and configuration information to prevent the BIOS from being illegally modified while an operating system (OS) is running.

With the conventional information processing apparatus described above, however, it is not possible to update the BIOS while the OS is running because the BIOS storage unit is locked. Therefore, with the conventional information processing apparatus, the update program is temporarily stored in a storage unit that is different from the BIOS storage unit, and when the information processing apparatus is restarted, the update program is written into the BIOS storage unit to update the BIOS. It leads to the problem that it takes a long time to restart the BIOS update.

### Summary

Embodiments of the present disclosure provide an information processing apparatus and a BIOS update method that enables a reduction in the time required to restart when updating the BIOS.

According to an aspect of the present invention, an information processing apparatus includes: a BIOS storage unit that stores at least a BIOS program; a main control unit that starts an OS by executing the BIOS program; and a sub-control unit that manages peripheral devices and is able to access the BIOS storage unit, wherein the BIOS storage unit has a first area that stores the current BIOS program and a second area for use in storing the BIOS update program, and wherein the sub-control unit has a BIOS update unit that stores the BIOS update program acquired by the main control unit in the second area during the BIOS update process, executes a restart, and enables the update program stored in the second area as the BIOS program.

According to the aspect of the present invention, in the above information processing apparatus, the BIOS update unit may change a reference destination used to access the BIOS program from the BIOS program in the first area to the update program in the second area at the time of the restart of the BIOS update process to enable the update program as the BIOS program.

Moreover, according to the aspect of the present invention, in the above information processing apparatus, the BIOS program in the first area may be set to be unchangeable by the OS, and the BIOS update unit may change the setting of the update program to be unchangeable by the OS when enabling the update program as the BIOS program.

Furthermore, according to the aspect of the present invention, the above information processing apparatus may further include a backup storage unit that stores a backup of the BIOS program, wherein, after enabling the update program as the BIOS program, the BIOS update unit may transfer the update program to the backup storage unit and store the update program therein, and wherein, in the case of failing in verifying the BIOS program, the sub-control unit may perform a recovery process of repairing the BIOS program that starts the OS using the backup stored in the backup storage unit.

Moreover, according to the aspect of the present invention, in the above information processing apparatus, the first area and the second area may be each independent storage devices.

Further, according to the aspect of the present invention, in the above information processing apparatus, the storage device may be an electrically rewritable memory chip, and be connected to the sub-control unit via an serial peripheral interface (SPI).

Still further, according to the aspect of the present invention, in the above information processing apparatus, the storage device that constitutes the second area may be an electrically rewritable memory chip or a solid state drive (SSD).

According to another aspect of the present invention, there is provided a BIOS update method for an information processing apparatus including a BIOS storage unit that stores at least a BIOS program, a main control unit that starts an OS by executing the BIOS program, and a sub-control unit that manages peripheral devices and is able to access the BIOS storage unit, wherein the BIOS storage unit has a first area that stores the current BIOS program and a second area for use in storing the BIOS update program, and wherein the BIOS update method includes a BIOS update step in which the sub-control unit stores the BIOS update program acquired by the main control unit in the second area during the BIOS update process, executes a restart, and enables the update program stored in the second area as the BIOS program.

One or more embodiments of the present invention can reduce the time required to restart when updating the BIOS.

### BRIEF DESCRIPTION OF THE DRAWINGS

FIG. 1 is a diagram illustrating an example of a main hardware configuration of a laptop PC according to one or more embodiments.

FIG. 2 is a block diagram illustrating an example of a functional configuration of the laptop PC according to one or more embodiments.

FIG. 3 is a first diagram for describing an example of a BIOS update process of the laptop PC according to one or more embodiments.

FIG. 4 is a second diagram for describing an example of the BIOS update process of the laptop PC according to one or more embodiments.

FIG. 5 is a third diagram for describing an example of the BIOS update process of the laptop PC according to one or more embodiments.

FIG. 6 is a fourth diagram for describing an example of the BIOS update process of the laptop PC according to one or more embodiments.

FIG. 7 is a flowchart illustrating an example of the BIOS update process of the laptop PC according to one or more embodiments.

FIG. 8 is a flowchart illustrating an example of a recovery process by BIOS backup of the laptop PC according to one or more embodiments.

FIG. 9 is a block diagram illustrating an example of a functional configuration of a laptop PC according to one or more embodiments.

### DETAILED DESCRIPTION

The following describes an information processing apparatus and a BIOS update method according to one or more embodiments of the present invention with reference to the drawings.

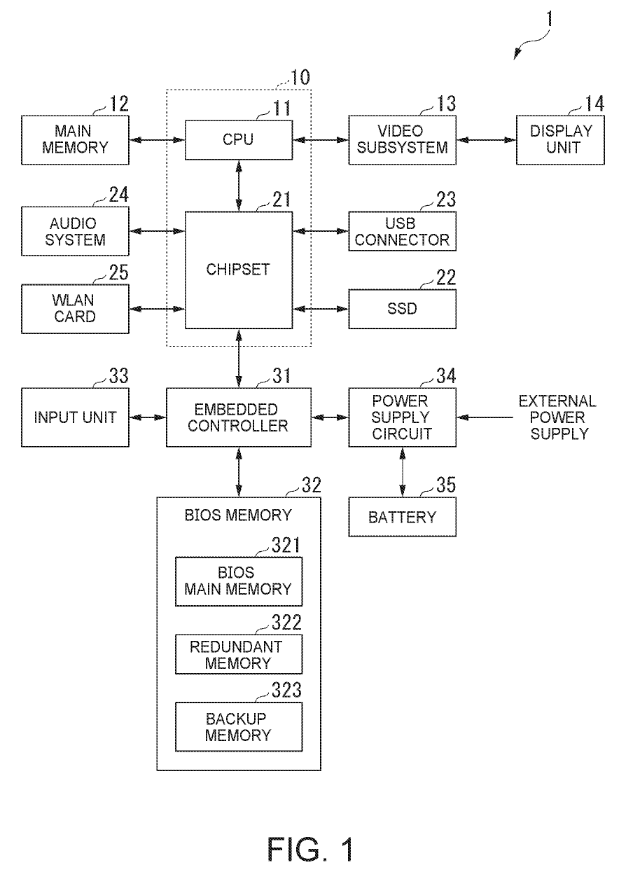

FIG. 1 is a diagram illustrating an example of a main hardware configuration of a laptop PC 1 according to one or more embodiments. In one or more embodiments, the laptop PC 1 (notebook type personal computer) is described as an example of the information processing apparatus.

As illustrated in FIG. 1, the laptop PC 1 includes a central processing unit (CPU) 11, a main memory 12, a video subsystem 13, a display unit 14, a chipset 21, an SSD 22, a USB connector 23, an audio system 24, a WLAN (wireless local area network) card 25, an embedded controller (EC) 31, a BIOS memory 32, an input unit 33, and a power supply circuit 34. In one or more embodiments, the CPU 11 and the chipset 21 correspond to a main control unit 10.

The CPU 11 executes various arithmetic processes under program control and controls the entire laptop PC 1. The main memory 12 is a writable memory that is used as a reading area for the execution program of the CPU 11 or as a work area for writing the processing data of the execution program. The main memory 12 is, for example, composed of multiple DRAM (dynamic random access memory) chips. This executable program includes the BIOS program, the OS, various drivers for hardware operation of peripheral devices, various services/utilities, application programs, and the like.

The video subsystem 13 is a subsystem for implementing functions related to image display, and includes a video controller. This video controller processes drawing instructions from the CPU 11, writes the processed drawing information to a video memory, and reads the drawing information from the video memory and outputs the drawing information as drawing data (display data) to the display unit 14.

The display unit 14 is, for example, a liquid crystal display, and displays a display screen based on the drawing data (display data) output from the video subsystem 13.

The chipset 21 has controllers for a USB (universal serial bus), a serial ATA (AT attachment), an SPI bus, a PCI (peripheral component interconnect) bus, a PCI-Express bus and an eSPI (embedded serial peripheral interface) bus, and the like, and multiple devices are connected thereto. In FIG. 1, as examples of devices, an SSD 22, a USB connector 23, an audio system 24, a WLAN card 25, and an embedded controller 31 are connected to the chipset 21.

The SSD 22 stores the OS, various drivers, various services/utilities, application programs and various data. The SSD 22 may be configured to be accessible via the embedded controller 31 from the chipset 21.

The USB connector 23 is a connector for use in connecting peripheral devices with USBs. The audio system 24 records, plays back, and outputs sound data. The WLAN card 25 connects to a network via a wireless LAN and performs data communication.

The embedded controller 31 (an example of a sub-control unit) is a one-chip microcomputer that monitors and controls various devices (peripheral devices, sensors, and the like) regardless of the system status of the laptop PC 1. In other words, the embedded controller 31 is an embedded controller that manages peripheral devices and is able to access the BIOS memory 32.

In addition, the embedded controller 31 has a power management function that controls the power supply circuit 34. In addition, the embedded controller 31 is configured with a CPU, a ROM, a RAM, and the like that are not illustrated, and is provided with multiple-channel A/D input terminals, D/A output terminals, timers, and digital input/output terminals. The embedded controller 31 is connected to, for example, the input unit 33, the power supply circuit 34, and the like via these input/output terminals, and the embedded controller 31 controls the operations of these devices.

In addition, the embedded controller 31 has an SPI and is connected to the BIOS memory 32 via the SPI. In one or more embodiments, for example, the BIOS memory 32 is connected to the embedded controller 31 by a slave attached flash method, and the main control unit 10 is able to access the BIOS memory 32 via the embedded controller 31. In the slave attached flash method, the main control unit 10 as a master is connected to the embedded controller 31, which is a slave, and further the BIOS memory 32 is connected as a slave to the embedded controller 31. This connection enables access from the embedded controller 31 to the BIOS memory 32, and also enables access from the main control unit 10 to the BIOS memory 32 via the embedded controller 31.

In addition, the embedded controller 31 is able to detect whether the laptop PC 1 is supplied with power from an external power supply or from the battery 35 built into the laptop PC 1 (a local apparatus) by means of the power supply circuit 34.

Furthermore, the embedded controller 31 performs a process to enable the update program by writing (storing) a BIOS update program, for example, into the BIOS memory 32 during the BIOS update process. The details of the BIOS update process are described later.

The BIOS memory 32 is composed of an electrically rewritable nonvolatile memory such as an electrically erasable programmable read only memory (EEPROM) or a flash ROM, for example. The BIOS memory 32 is connected to the embedded controller 31 by a method in which the main control unit 10 is able to access the BIOS memory 32 via the embedded controller 31, such as a slave attached flash method, by which the BIOS memory 32 is able to be accessed from the main control unit 10 via the embedded controller 31. The BIOS memory 32 stores system firmware and the like used to control the BIOS, the embedded controller 31, and the like. The BIOS memory 32 stores, for example, BIOS programs, various configuration information, and so on. The BIOS memory 32 also stores digest values (hash values) obtained in advance from BIOS program data.

In addition, the BIOS memory 32 includes a BIOS main memory 321, a redundant memory 322, and a backup memory 323. The BIOS main memory 321 is an SPI memory (an example of a storage device) connected to the embedded controller 31 via the SPI, and mainly stores the BIOS main program, configuration information, various firmware, and so on.

The redundant memory 322 is an SPI memory (an example of a storage device) connected to the embedded controller 31 via the SPI, and stores the BIOS update program described later.

The backup memory 323 is an SPI memory (an example of a storage device) connected to the embedded controller 31 via the SPI, and stores backups of the BIOS program.

The input unit 33 is an input device such as, for example, a keyboard, a pointing device, a touchpad, or the like. The power supply circuit 34 includes, for example, a DC/DC converter, a charging/discharging unit, and so on, and converts the direct current voltage supplied from an external power supply from an AC/DC adapter or from the battery 35 into the multiple voltages necessary for operating the laptop PC 1. The power supply circuit 34 also supplies power to each part of the laptop PC 1, based on control from the embedded controller 31.

The battery 35 is, for example, a lithium-ion battery, and is charged by the power supply circuit 34 when an external power supply from the AC/DC adapter is supplied. The battery 35 also supplies power to each component of the laptop PC 1 via the power supply circuit 34 in a state where the external power supply from the AC/DC adapter is not supplied.

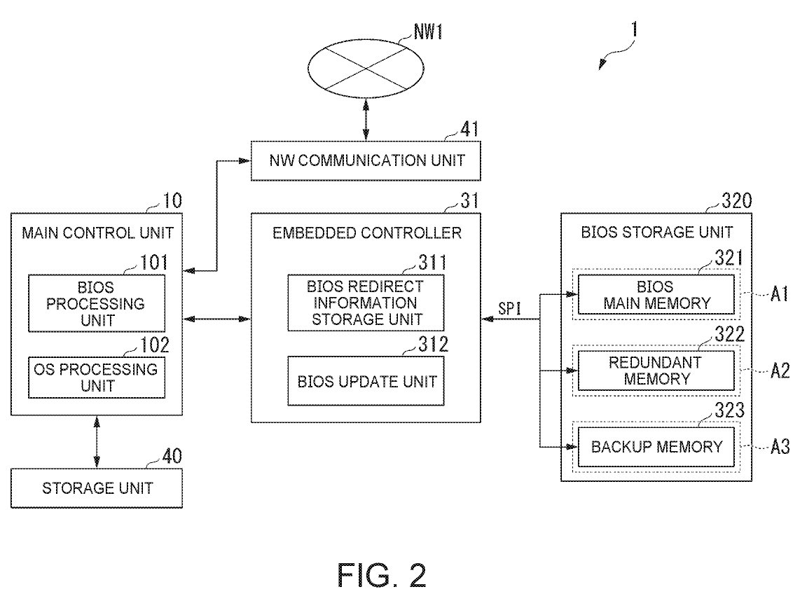

Subsequently, referring to FIG. 2, the functional configuration of the laptop PC 1 according to one or more embodiments is described. FIG. 2 is a block diagram illustrating an example of the functional configuration of the laptop PC 1 according to one or more embodiments. As illustrated in FIG. 2, the laptop PC 1 includes the main control unit 10, the embedded controller 31, a storage unit 40, a network (NW) communication unit 41, and a BIOS storage unit 320. In FIG. 2, only the main functional configuration related to the invention of one or more embodiments is illustrated.

The storage unit 40 is, for example, a storage unit implemented by the main memory 12, and stores various information used by the laptop PC 1. The storage unit 40 stores various information used for BIOS processing and OS processing, for example.

The NW communication unit 41 is a functional unit implemented by, for example, a WLAN card 25 or the like, and connects to a network NW1 via network communication such as wireless LAN or wired LAN to perform data communication. The NW communication unit 41 is used, for example, to acquire a BIOS update program.

The main control unit 10 has the CPU 11 and the chipset 21, and starts up an OS (for example, Windows [registered trademark]) by executing a BIOS program. After the OS is started, the main control unit 10 executes various applications that operate on the OS. The main control unit 10 includes, for example, a BIOS processing unit 101 and an OS processing unit 102.

The BIOS processing unit 101 is a functional unit that is implemented by causing the CPU 11 to execute the BIOS program, and performs various BIOS processes. The BIOS processing unit 101, for example, performs the process of starting up the OS. The OS processing unit 102 is a functional unit that is implemented by causing the CPU 11 to execute the OS program, and performs various OS processes.

The BIOS storage unit 320 is, for example, a storage unit that is implemented by the BIOS memory 32, and stores at least the BIOS program. The BIOS storage unit 320 includes the BIOS main memory 321, the redundant memory 322, and the backup memory 323 described above. In one or more embodiments, the BIOS main memory 321 corresponds to a main area A1 of the BIOS storage unit 320, and the redundant memory 322 corresponds to a redundant area A2 of the BIOS storage unit 320. In addition, the backup memory 323 corresponds to a backup area A3 of the BIOS storage unit 320. In other words, the BIOS storage unit 320 has the main area A1 (first area), the redundant area A2 (second area), and the backup area A3 (third area).

The main area A1 is an area that stores the current BIOS program. The redundant area A2 is an area for use in storing the BIOS update program. The backup area A3 is an area for use in storing the backup of the BIOS program, and is an example of a backup storage unit.

In one or more embodiments, the BIOS main memory 321 (main area A1), the redundant memory 322 (redundant area A2), and the backup memory 323 (backup area A3) are connected in such a way as to be able to be accessed from the embedded controller 31 via the SPI. In one or more embodiments, the main area A1, the redundant area A2, and the backup area A3 are each independent storage devices (SPI memories).

The embedded controller 31 includes a BIOS redirect information storage unit 311 and a BIOS update unit 312. The BIOS redirect information storage unit 311 stores redirect information that indicates a reference destination used for accessing the BIOS program.

In the BIOS update process, the BIOS update unit 312 stores the BIOS update program acquired by the main control unit 10 into the redundant area A2, and performs a restart to enable the update program stored in the redundant area A2 as the BIOS program.

For example, when restarting the BIOS update process, the BIOS update unit 312 changes the reference destination used to access the BIOS program from the BIOS program in the main area A1 to the update program in the redundant area A2, and enables the update program as the BIOS program. In other words, the BIOS update unit 312 changes redirect information stored in the BIOS redirect information storage unit 311 from the main area A1 to the redundant area A2 to disable the BIOS program in the main area A1, while enabling the update program as the BIOS program.

In addition, when enabling the update program as the BIOS program, the BIOS update unit 312 changes the setting to prevent modification of the update program from the OS. The BIOS update unit 312 locks the redundant area A2 so that the OS is not able to directly access the BIOS program in the redundant area A2, which is an update program.

In addition, after enabling the update program as the BIOS program, the BIOS update unit 312 transfers the update program to the backup area A3 to store the update program therein. Furthermore, in the case of failing to verify the validity of the BIOS program in a POST (power on self test) that is executed when starting up the OS, the embedded controller 31 performs a recovery process that repairs the BIOS program that starts up the OS using the backup stored in the backup area A3.

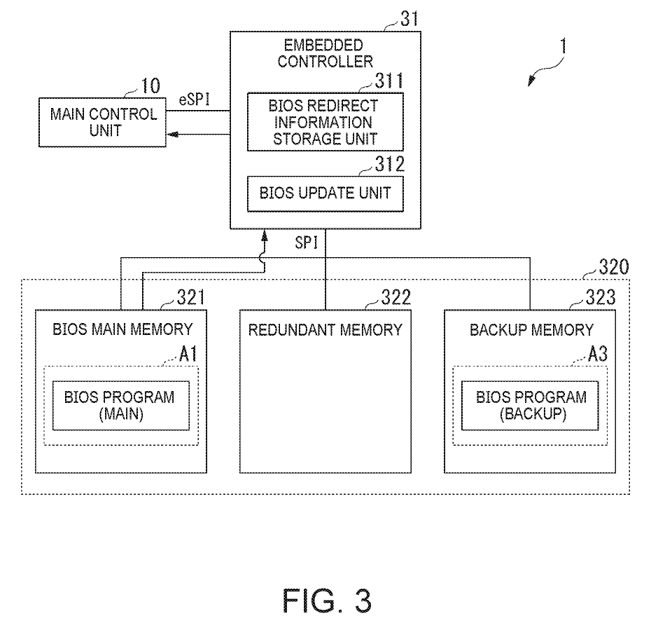

Next, referring to the drawings, the operation of the laptop PC 1 according to one or more embodiments is described. First, referring to FIGS. 3 to 6, the details of the BIOS update process of the laptop PC 1 according to one or more embodiments are described. FIGS. 3 to 6 illustrate examples of the BIOS update process of the laptop PC 1 according to one or more embodiments.

FIG. 3 illustrates the state of the laptop PC 1 before the BIOS is updated, and illustrates startup processes of the BIOS and OS in the state before the BIOS is updated. As illustrated in FIG. 3, when the laptop PC 1 is turned on or reset (restarted), the main control unit 10 accesses the main area A1 of the BIOS storage unit 320 via the embedded controller 31 using eSPI, reads (loads) the BIOS program (hereinafter, referred to as the BIOS program in some cases), and starts the BIOS. In addition, the main control unit 10 uses the BIOS to start up the OS.

In the state illustrated in FIG. 3, the backup area A3 contains the same BIOS program as that stored in the main area A1 as a backup of the BIOS program. Furthermore, after the OS is started, the BIOS program (main) in the main area A1 is locked so that the OS is not able to directly access the BIOS program.

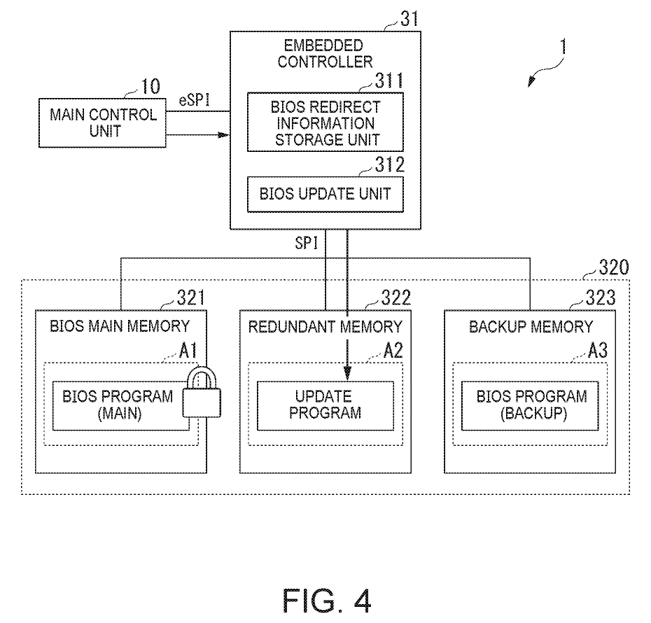

Next, referring to FIG. 4, the details of the update program writing process (storage process) are described in the BIOS update process of the laptop PC 1. As illustrated in FIG. 4, the main control unit 10 transfers the BIOS update program (hereafter, simply referred to as “update program” in some cases) that the main control unit 10 has acquired via the network NW1 and the NW communication unit 41 to the embedded controller 31. The BIOS update unit 312 of the embedded controller 31 determines the redundant area A2 (in this specification, the area in the redundant memory 322) in the BIOS storage unit 320 and stores the update program acquired from the main control unit 10 in the redundant area A2.

The reason why the BIOS update unit 312 stores the update program in the redundant area A2 is that the main area A1 is locked and therefore the update program is not able to be directly stored in the main area A1. In addition, after storing the update program in the redundant area A2, the BIOS update unit 312 performs a restart (global reset).

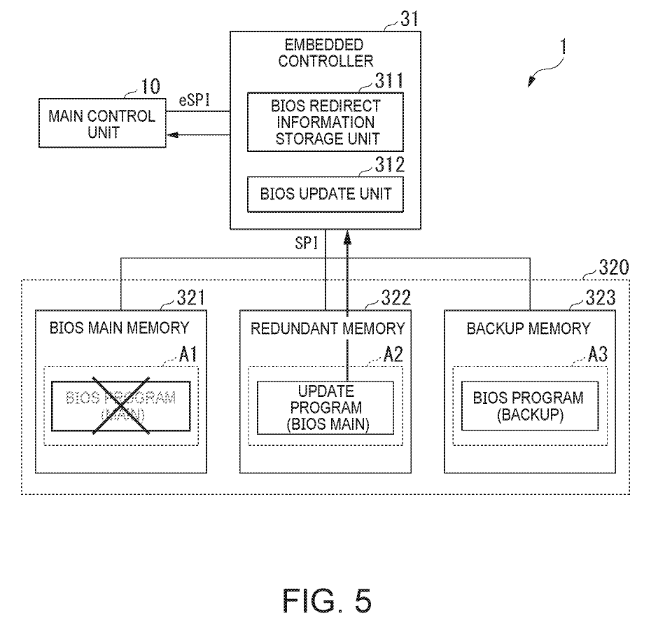

Referring to FIG. 5, the following describes the restart process after the update program has been stored in the redundant area A2. As illustrated in FIG. 5, in the restart process, the BIOS update unit 312 enables the update program in the redundant area A2 and disables the BIOS program in the main area A1, and then starts up the BIOS using the update program.

The BIOS update unit 312 changes the redirect information of the reference destination for the BIOS program stored in the BIOS redirect information storage unit 311, from the main area A1 to the redundant area A2, enables the update program, and disables the BIOS program in the main area A1.

In addition, the embedded controller 31 reads (loads) the update program in the redundant area A2 as the latest BIOS program and transfers the update program to the main control unit 10. The main control unit 10 reads (loads) the update program in the redundant area A2 via the embedded controller 31 and starts up the BIOS and the OS.

The main control unit 10 uses eSPI to access the main area A1 of the BIOS storage unit 320 via the embedded controller 31, reads (loads) the BIOS program (hereinafter, referred to as the BIOS program in some cases), and starts up the BIOS. The main control unit 10 also uses the BIOS to start up the OS. Moreover, after the OS is started, the update program in the redundant area A2 is locked so that the OS is not able to directly access the update program.

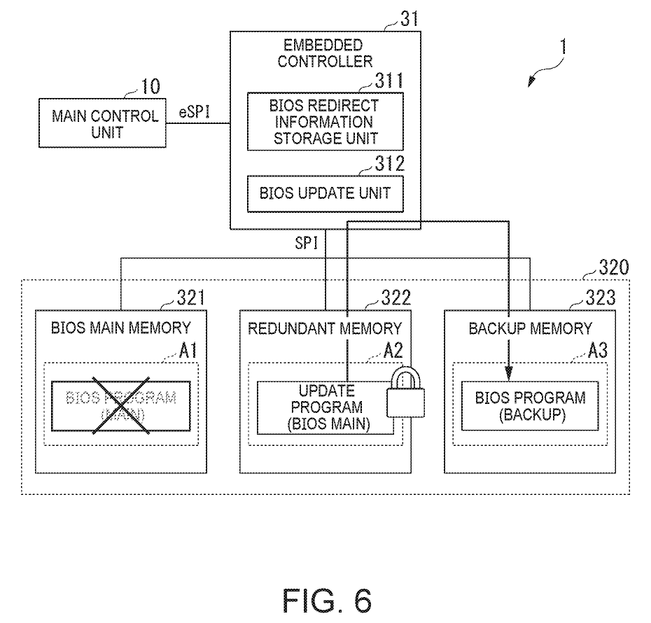

Next, referring to FIG. 6, the backup process of the BIOS program (update program) after restarting is described. As illustrated in FIG. 6, the BIOS update unit 312 of the embedded controller 31 transfers the update program in the redundant area A2 to the backup area A3 of the BIOS storage unit 320 and stores the update program as a backup of the BIOS program.

In addition, after the BIOS update process, the BIOS update unit 312 may treat the redundant area A2, which has been enabled as the BIOS program, as the main area during the next BIOS update, and may treat the main area A1, which has been disabled, as the redundant area for the next BIOS update, or may treat other free areas of the redundant memory 322 as the next redundant area.

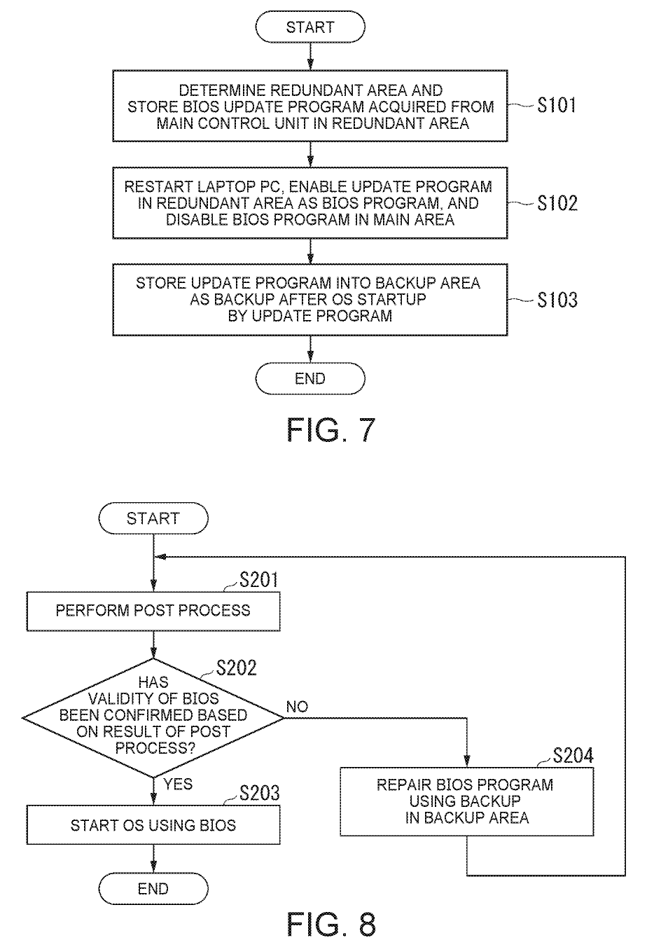

Referring to FIG. 7, the following describes the operation of the embedded controller 31 in the BIOS update process of the laptop PC 1 according to one or more embodiments.

FIG. 7 is a flowchart illustrating an example of the BIOS update process of the laptop PC 1 according to one or more embodiments.

As illustrated in FIG. 7, the embedded controller 31 of the laptop PC 1, in the BIOS update process, first determines the redundant area A2 and stores the BIOS update program acquired from the main control unit 10 into the redundant area A2 (step S101). The BIOS update unit 312 of the embedded controller 31 stores the update program, which has been acquired from the main control unit 10 using eSPI, into the redundant area A2 using SPI. The BIOS update unit 312 determines the redundant area A2, for example, from the free area of the redundant memory 322.

Subsequently, the BIOS update unit 312 restarts the laptop PC 1, enables the update program in the redundant area A2 as the BIOS program, and disables the BIOS program in the main area A1 (step S102). The BIOS update unit 312, for example, performs a global reset and restarts the laptop PC 1, and further changes the redirect information stored in the BIOS redirect information storage unit 311 from the main area A1 to the redundant area A2. This enables the update program in the redundant area A2 and disables the BIOS program in the main area A1.

In addition, with the restart of the laptop PC 1, the BIOS update unit 312 reads the update program in the redundant area A2 using the redirect information in the BIOS redirect information storage unit 311 in response to a request to read the BIOS program of the main control unit 10, and transmits the update program to the main control unit 10. This starts the BIOS using the update program.

Then, the BIOS update unit 312 stores the update program into the backup area A3 as a backup after the OS has been started using the update program (step S103). The BIOS update unit 312 reads the update program in the redundant area A2 as a runtime process after the OS has been started and stores the update program in the backup area A3 as a backup. After the processing of step S103, the BIOS update unit 312 terminates the BIOS update process.

Referring to FIG. 8, the following describes the recovery process of the BIOS of the laptop PC 1 according to one or more embodiments. FIG. 8 is a flowchart illustrating an example of the recovery process by BIOS backup of the laptop PC 1 according to one or more embodiments.

As illustrated in FIG. 8, the embedded controller 31 of the laptop PC 1 performs the POST process (step S201) first when the laptop PC 1 is started up. The embedded controller 31, for example, confirms the validity of the BIOS program using a digest value (hash value) obtained in advance from the BIOS program data.

Subsequently, the embedded controller 31 determines whether the validity of the BIOS has been confirmed based on the result of the POST process (step S201). When the validity of the BIOS is confirmed as a result of the POST process (step S202: YES), the embedded controller 31 proceeds to step S203. When the validity of the BIOS is not confirmed as a result of the POST process (step S202: NO), the embedded controller 31 proceeds to step S204.

In step S203, the laptop PC 1 starts up the OS using the BIOS. In other words, the main control unit 10 of the laptop PC 1 reads (loads) the BIOS program via the embedded controller 31 and starts up the OS by executing the BIOS program. After the processing in step S203, the startup process of the laptop PC 1 is terminated.

Furthermore, in step S204, the embedded controller 31 repairs the BIOS program using the backup in the backup area A3. The embedded controller 31 reads the backup of the BIOS program stored in the backup area A3 and re-writes the backup into the area (the main area A1 or the redundant area A2) where the current BIOS program is stored. Note that the embedded controller 31 determines the area, to which the backup is rewritten, based on the redirect information stored in the BIOS redirect information storage unit 311. After the processing in step S204, the embedded controller 31 returns the processing to step S101.

In the above description, the example was given of the embedded controller 31 performing the processing of step S101 and step S202, but the main control unit 10 may perform the processing instead of the embedded controller 31.

As described above, the laptop PC 1 (information processing apparatus) of one or more embodiments includes the BIOS storage unit 320, the main control unit 10, and the embedded controller 31 (sub-control unit). The BIOS storage unit 320 (BIOS memory 32) stores at least the BIOS program. The main control unit 10 starts up the OS by executing the BIOS program. The embedded controller 31 (sub-control unit) manages peripheral devices and is configured to be able to access the BIOS storage unit 320. The BIOS storage unit 320 has the main area A1 (first area) that stores the current BIOS program and the redundant area A2 (second area) for use in storing the BIOS update program. The embedded controller 31 has the BIOS update unit 312. In the BIOS update process, the BIOS update unit 312 causes the BIOS update program acquired by the main control unit 10 to be stored in the redundant area A2, and performs a restart to enable the update program stored in the redundant area A2 as the BIOS program.

As a result, the laptop PC 1 (information processing apparatus) of one or more embodiments does not need to move the update program to the main area A1 when restarting, because the laptop PC 1 enables the BIOS update program stored in the redundant area A2 (second area) as the BIOS program and directly uses the BIOS update program. Therefore, the laptop PC 1 (information processing apparatus) of one or more embodiments is able to reduce the time required to restart when updating the BIOS.

In addition, in the laptop PC 1 of one or more embodiments, the BIOS program before updating remains in the main area A1. Therefore, the BIOS update unit 312 disables the BIOS program stored in the redundant area A2 and enables the BIOS program stored in the main area A1 again, by which the laptop PC 1 of one or more embodiments is able to safely and easily return the BIOS to the program before updating.

In one or more embodiments, when the BIOS update process is restarted, the BIOS update unit 312 changes the reference destination used to access the BIOS program from the BIOS program in the main area A1 to the update program in the redundant area A2, and enables the update program as the BIOS program.

As a result, the laptop PC 1 of one or more embodiments is able to enable the update program as the BIOS program by a simple method of changing the reference destination used for access. In addition, in the laptop PC 1 of one or more embodiments, the main control unit 10 does not need to be aware that the storage location of the BIOS program has been changed by the update process, thereby achieving the effect of being able to use the processing of the conventional main control unit as it is.

Furthermore, in one or more embodiments, the BIOS program in the main area A1 is set to be unchangeable by the OS. When enabling the update program as the BIOS program, the BIOS update unit 312 changes the setting of the update program to be unchangeable by the OS.

Thereby, the laptop PC 1 of one or more embodiments is not able to change the BIOS program from the OS, and therefore is able to protect the BIOS program and to prevent the BIOS program from being illegally modified.

Furthermore, the laptop PC 1 of one or more embodiments includes a backup area A3 (an example of a backup storage unit) for use in storing a backup of the BIOS program. The BIOS update unit 312 transfers the update program to the backup area A3 and stores the update program therein after enabling the update program as the BIOS program. In the case of failing in verification of the BIOS program, the embedded controller 31 performs a recovery process of repairing the BIOS program that starts the OS using the backup stored in the backup area A3.

As a result, the laptop PC 1 of one or more embodiments is able to safely repair and restore the BIOS program when, for example, the BIOS program is corrupted due to memory data corruption in the BIOS memory 32.

In one or more embodiments, the main area A1 and the redundant area A2 are each independent storage devices (SPI memory). Note that the storage device is an electrically rewritable memory chip and is connected to the embedded controller 31 via SPI.

Thereby, the laptop PC 1 of one or more embodiments is able to greatly increase the BIOS program area and easily expand the functions by configuring each of the areas as an independent storage device (SPI memory).

In addition, the BIOS update method according to one or more embodiments is a BIOS update method for a laptop PC 1 that includes a BIOS storage unit 320 that stores at least a BIOS program, a main control unit 10 that starts the OS by executing the BIOS program, and an embedded controller 31 that manages peripheral devices and is able to access the BIOS storage unit 320, the method including a BIOS update step. The BIOS storage unit 320 has a main area A1 that stores the current BIOS program and a redundant area A2 for use in storing the BIOS update program. In the BIOS update step, the embedded controller 31 stores the BIOS update program acquired by the main control unit 10 in the redundant area A2 during the BIOS update process, executes a restart, and enables the update program stored in the redundant area A2 as the BIOS program.

Thereby, the BIOS update method according to one or more embodiments has the same effect as the laptop PC 1 described above, and is able to reduce the time required to restart when updating the BIOS.

The following describes a laptop PC 1a according to one or more embodiments, referring to the drawings. In one or more embodiments, a variation in which a backup storage unit 221 configured with an SSD 22 is used instead of the backup memory 323.

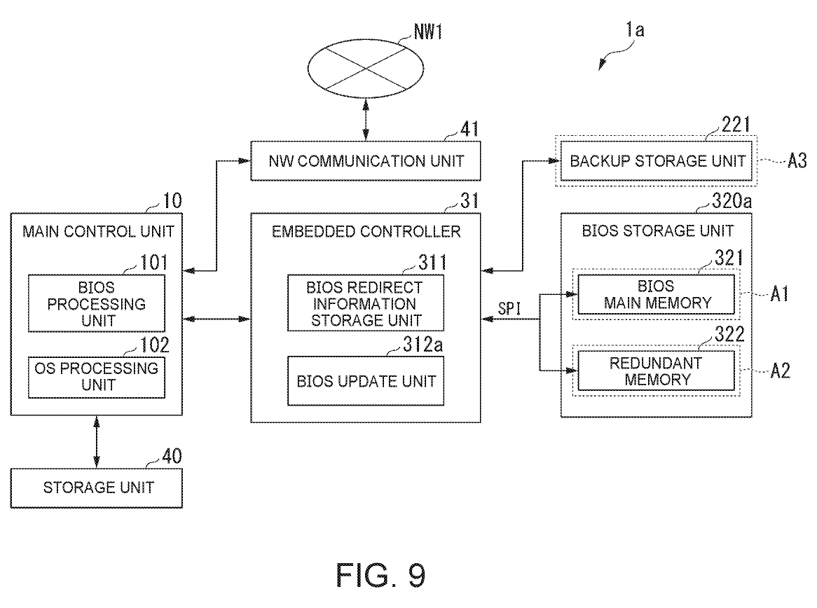

FIG. 9 is a block diagram illustrating an example of a functional configuration of the laptop PC 1a according to one or more embodiments. The main hardware configuration of the laptop PC 1a according to the present embodiment is the same as that of the above-described embodiments illustrated in FIG. 1 described above, and therefore the description thereof is omitted here.

As illustrated in FIG. 9, the laptop PC 1a includes a main control unit 10, an embedded controller 31, a storage unit 40, a NW communication unit 41, a BIOS storage unit 320a, and a backup storage unit 221. In FIG. 9, the same reference numerals are used as in FIG. 2 to indicate the same components, and the description thereof is omitted.

The BIOS storage unit 320a is a storage unit that is implemented by the BIOS memory 32, for example, and stores at least a BIOS program. The BIOS storage unit 320a includes the above-described BIOS main memory 321 and redundant memory 322.

The backup storage unit 221 is a storage unit that is implemented by the SSD 22, for example, and stores a backup of the BIOS program, similarly to the backup memory 323 of the above-described embodiments. In one or more embodiments, the backup storage unit 221 corresponds to the backup area A3.

In addition, the embedded controller 31 of one or more embodiments includes a BIOS redirect information storage unit 311 and a BIOS update unit 312a. The basic functions of the BIOS update unit 312a are the same as those of the BIOS update unit 312 of the embodiments described above, except that the backup storage unit 221 is used in the backup area A3 instead of the backup memory 323.

In one or more embodiments, there has been described an example in which the backup storage unit 221 is implemented by the SSD 22, but the redundant area A2 (redundant memory 322) may be implemented by the SSD 22. In other words, the storage device that constitutes the redundant area A2 may be an electrically rewritable memory chip or the SSD 22.

As described above, the laptop PC 1a of one or more embodiments includes the BIOS storage unit 320a, the main control unit 10, and the embedded controller 31 (sub-control unit). The BIOS storage unit 320a (BIOS memory 32) stores at least the BIOS program. The BIOS storage unit 320a has a main area A1 (first area) that stores the current BIOS program and a redundant area A2 (second area) that stores the BIOS update program. The embedded controller 31 has the BIOS update unit 312a. In the BIOS update process, the BIOS update unit 312a stores the BIOS update program acquired by the main control unit 10 in the redundant area A2, performs a restart, and enables the update program stored in the redundant area A2 as the BIOS program.

Thereby, the laptop PC 1a of one or more embodiments has the same effect as the embodiments described above, and is able to reduce the time required to restart when updating the BIOS.

Furthermore, the laptop PC 1a of one or more embodiments includes the backup storage unit 221 (backup area A3) for use in storing a backup of the BIOS program. The BIOS update unit 312 transfers the update program to the backup storage unit 221 and stores the update program therein after enabling the update program as the BIOS program. In the case of failing in the verification of the BIOS program, the embedded controller 31 performs a recovery process of repairing the BIOS program that starts the OS using the backup stored in the backup storage unit 221.

As a result, the laptop PC 1a of one or more embodiments is able to safely repair and restore the BIOS program when, for example, the BIOS program is corrupted due to memory data corruption in the BIOS memory 32.

Moreover, in one or more embodiments, the main area A1 and the redundant area A2 are each independent storage devices. The storage device that constitutes the redundant area A2 may be an electrically rewritable memory chip or an SSD 22.

Thereby, the laptop PC 1 of one or more embodiments is able to greatly increase the BIOS program area and to easily expand the functions by using the electrically rewritable memory chip or the SSD 22 as the redundant area A2.

The present invention is not limited to the above embodiments, and may be modified within the scope of not deviating from the gist of the present invention. For example, in the above embodiments, the example of the information processing apparatus being a laptop PC 1 has been described, but the information processing apparatus is not limited thereto, and may be any other information processing apparatus such as a tablet terminal or a desktop PC.

Furthermore, in the above embodiments, an example was given of the redundant area A2 and the backup area A3 being provided outside the BIOS main memory 321, but the present invention is not limited thereto, and the redundant area A2 and the backup area A3 may be provided inside the BIOS main memory 321.

Further, in the above embodiments, an example was given of the laptop PC 1(1a) acquiring a BIOS update file via the network NW1, but the BIOS update file may also be acquired as a capsule file encapsulated using an encryption technique. In this case, by using a capsule file, the laptop PC 1(1a) is able to reduce the possibility of the BIOS update program being tampered with during transfer, and to perform the BIOS update process safely.

Each of the configurations of the laptop PC 1(1a) described above has a computer system inside. The processes of each of the configurations of the above-described laptop PC 1 (1a) may be performed by recording a program for implementing the functions of each of the configurations of the laptop PC 1(1a) described above on a computer-readable recording medium, causing the computer system to read the program recorded on the recording medium, and executing the program. Note that “causing the computer system to read the program recorded on the recording medium, and executing the program” includes installing the program on the computer system. The term “computer system” as used here shall include hardware such as the OS and peripheral devices. In addition, the term “computer system” may include multiple computer devices connected via a network such as the Internet, WAN, LAN, and a dedicated line. In addition, the term “computer-readable recording medium” refers to a storage device such as a portable medium such as a flexible disk, a magnetooptical disk, a ROM, and a CD-ROM, or a hard disk built in a computer system. Thus, the recording medium that stores a program may be a non-transitory recording medium such as CD-ROM.

Furthermore, the recording medium includes a recording medium that is internally or externally provided and is able to be accessed from a distribution server in order to distribute the program. Furthermore, the program may be divided into multiple parts, and each part may be downloaded at different timings and then combined in the respective configurations of the laptop PC 1 (1a), or the distribution servers that distribute each of the divided parts of the program may be different. Furthermore, the term “computer-readable recording medium” shall include those that hold programs for a certain period of time, such as a volatile memory (RAM) inside the computer system that serves as a server or a client when a program is sent via a network. In addition, the above-described programs may be used to implement some of the functions described above. Furthermore, the programs may be those capable of implementing the above-described functions by combining the functions with programs already recorded in the computer system, so-called differential files (difference programs).

In addition, some or all of the above-described functions may be implemented as an integrated circuit such as LSI (large scale integration). Each of the above functions may be implemented as a processor individually, or some or all of the functions may be integrated and implemented as a processor. Furthermore, the method of implementing an integrated circuit is not limited to LSI, but may be implemented using a dedicated circuit or a general-purpose processor. In addition, when a technique of implementing an integrated circuit that replaces LSI appears due to advances in semiconductor technology, an integrated circuit using the technique may be used.

### Description of Symbols

1, 1a laptop PC

10 main control unit

11 CPU

12 main memory

13 video subsystem

14 display unit

21 chipset

22 SSD

23 USB connector

24 audio system

25 WLAN card

31 embedded controller (EC)

32 BIOS memory

33 input unit

34 power supply circuit

35 battery

40 storage unit

41 NW communication unit

101 BIOS processing unit

102 OS processing unit

221 backup storage unit

311 BIOS redirect information storage unit

312, 312a BIOS update unit

320, 320a BIOS storage unit

321 BIOS main memory

322 redundant memory

323 backup memory

A1 main area

A2 redundant area

A3 backup area

NW1 network

What is claimed is:

1. An information processing apparatus comprising:
a BIOS storage unit that stores at least a BIOS program;
a main control unit that starts an OS by executing the BIOS program; and
a sub-control unit that manages peripheral devices and is able to access the BIOS storage unit,
wherein the BIOS storage unit has a first area that stores a current BIOS program and a second area for use in storing a BIOS update program, and
wherein the sub-control unit has a BIOS update unit that stores the BIOS update program acquired by the main control unit in the second area during the BIOS update process, executes a restart, and enables the update program stored in the second area as the BIOS program.

2. The information processing apparatus according to claim 1, wherein the BIOS update unit changes a reference destination used to access the BIOS program from the BIOS program in the first area to the update program in the second area at a time of the restart of the BIOS update process to enable the update program as the BIOS program.

3. The information processing apparatus according to claim 2,
wherein the BIOS program in the first area is set to be unchangeable by the OS, and
wherein the BIOS update unit changes the setting of the update program to be unchangeable by the OS when enabling the update program as the BIOS program.

4. The information processing apparatus according to claim 3, further comprising a backup storage unit that stores a backup of the BIOS program,
wherein, after enabling the update program as the BIOS program, the BIOS update unit transfers the update program to the backup storage unit and stores the update program therein, and
wherein, in response to failing to verify the BIOS program, the sub-control unit performs a recovery process of repairing the BIOS program that starts the OS using the backup stored in the backup storage unit.

5. The information processing apparatus according to claim 3, wherein the first area and the second area are each independent storage devices.

6. The information processing apparatus according to claim 5, wherein the storage device is an electrically rewritable memory chip, and is connected to the sub-control unit via an SPI.

7. The information processing apparatus according to claim 5, wherein the storage device that constitutes the second area is an electrically rewritable memory chip or an SSD.

8. A BIOS update method for an information processing apparatus including a BIOS storage unit that stores at least a BIOS program, a main control unit that starts an OS by executing the BIOS program, and a sub-control unit that manages peripheral devices and is able to access the BIOS storage unit,
wherein the BIOS storage unit has a first area that stores a current BIOS program and a second area for use in storing a BIOS update program, and
wherein the BIOS update method comprises a BIOS update step in which the sub-control unit stores the BIOS update program acquired by the main control unit in the second area during the BIOS update process, executes a restart, and enables the update program stored in the second area as the BIOS program.
